(19) United States
(12) Patent Application Publication
(10) Pub. No.: US 2003/0169304 A1
(43) Pub. Date: Sep. 11, 2003

(54) Pull-down menu manipulation of multiple open document windowns

(75) Inventor: William Gabriel Pagan, Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/092,840

(22) Filed: Mar. 7, 2002

(51) Int. Cl. G09G 5/00

(52) U.S. Cl. 345/843

(57) ABSTRACT

A method, system and apparatus for manipulating multiple open document windows through a pull-down menu in an activated open document window. A method for manipulating multiple open document windows through a pull-down menu can include creating a pull-down menu in the activated open document window having a listing of open document windows and corresponding interactive user interface elements. Responsive to the activation of one of the interactive user interface elements, a pre-defined window manipulation operation can be performed upon an inactive open document window corresponding to the activated interactive user interface element. Though the invention is not so limited, the pre-defined window manipulation operation can include one of a window close operation, a print window operation, and a file save operation.

### BACKGROUND OF THE INVENTION

1. Statement of the Technical Field

The present invention relates to the field of graphical user interfaces and more particularly to the manipulation of multiple open document windows in a graphical user interface.

2. Description of the Related Art

The conventional graphical user interface (GUI) has been widely used for many years. Applications which incorporate GUI designs generally fall within one of two categories: the single document interface (SDI) architecture and the multiple document interface (MDI) architecture. In the SDI architecture, a primary application window encloses each document window launched therefrom. Closing the primary application window in an SDI architecture will cause the closure of all document windows contained therein. In the MDI architecture, by comparison, no primary application window is required and each document window exists separately from other document windows.

Generally, the operation of both SDI and MDI based applications include the opening and display of one or more document windows in which documents such as word processing documents, spreadsheet documents, computer source code documents, image documents and the like can be processed. Of course, in many operating systems which support GUI applications, only a single document window can be active at any one time. To activate a particular document window, typically the document window can be selected graphically with a pointing device, or by pull-down menu. Other user interface mechanisms exist for cycling between document windows, including window toggling operations and window listing operations.

When the processing of any one document in an SDI or MDI application has been completed, the document window hosting the document can be closed simply by executing a Window|Close, File|Close or other such analogous GUI operation. Similarly, where the processing of multiple documents has been completed, each document window hosting one of the multiple documents can be closed also by executing a corresponding Window|Close or File|Close operation. Where all document windows are to be closed, some SDI and MDI applications provide for a Window|CloseAll or File|CloseAll operation.

Presently, SDI and MDI applications provide no facility, however, for manipulating selected open document windows in a centralized and convenient manner. Where few document windows have been opened in a particular SDI or MDI application, no centralized facility will be required as little extra effort can be required to individually select and close particular document windows in an SDI or MDI application. Still, where many document windows have been opened in an SDI or MDI application, selecting and closing individual ones of the document window can become burdensome.

The problem can be compounded, as illustrated in FIG. 1, where screen space 110 is limited and it is not possible to view all open document windows 120A, 120B, 120C, 120D, 120E. In the conventional case, all open document windows 120A, 120B, 120C, 120D, 120E can be accounted for through the menu bar 130 of any one document window 120A, 120B, 120C, 120D, 120E. In particular, in some SDI and MDI applications, a window list 140 can provide a list of all open document windows 120A, 120B, 120C, 120D, 120E. Yet, to close each open document window 120A, 120B, 120C, 120D, 120E, each open document window 120A, 120B, 120C, 120D, 120E still must be selected and closed individually. As will be apparent to one skilled in the art, this process can be inefficient and burdensome.

### SUMMARY OF THE INVENTION

The present invention is a method, system and apparatus for manipulating multiple open document windows through a pull-down menu in an activated open document window. A method for manipulating multiple open document windows through a pull-down menu can include creating a pull-down menu in the activated open document window having a listing of open document windows and corresponding interactive user interface elements. Responsive to the activation of one of the interactive user interface elements, a pre-defined window manipulation operation can be performed upon an inactive open document window corresponding to the activated interactive user interface element. Though the invention is not so limited, the pre-defined window manipulation operation can include one of a window close operation, a print window operation, and a file save operation.

Notably, in one aspect of the invention, the performing step can include generating a window manipulation event responsive to the activation of the interactive user interface element. Subsequently, the window manipulation event can be processed in a message handling routine associated with the activated open document window. In particular, the processing can include identifying the inactive open document window corresponding to the interactive user interface element, and posting a window manipulation event to the identified inactive open document window. Finally, the posted window manipulation event can be processed in a message handling routine associated with the inactive open document window.

A system for manipulating multiple open document windows can include a pull-down menu disposed in an active open document window. A list of open document windows can be disposed in the pull-down menu as can a set of activatable interactive user elements. The system also can include an event handler configured to post pre-defined window manipulation events to inactive open document windows associated with activated ones of the activatable interactive user elements.

Each activatable interactive user element can correspond to one of the listed open document windows. Furthermore, each activatable interactive user element can have a screen position in the pull-down menu which is adjacent to the corresponding listed open document window. Notably, each activatable interactive user element can be a button. Also, the pre-defined window manipulation events can include close window events.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a screen shot of a multiple document interface architected application as is known in the prior art;

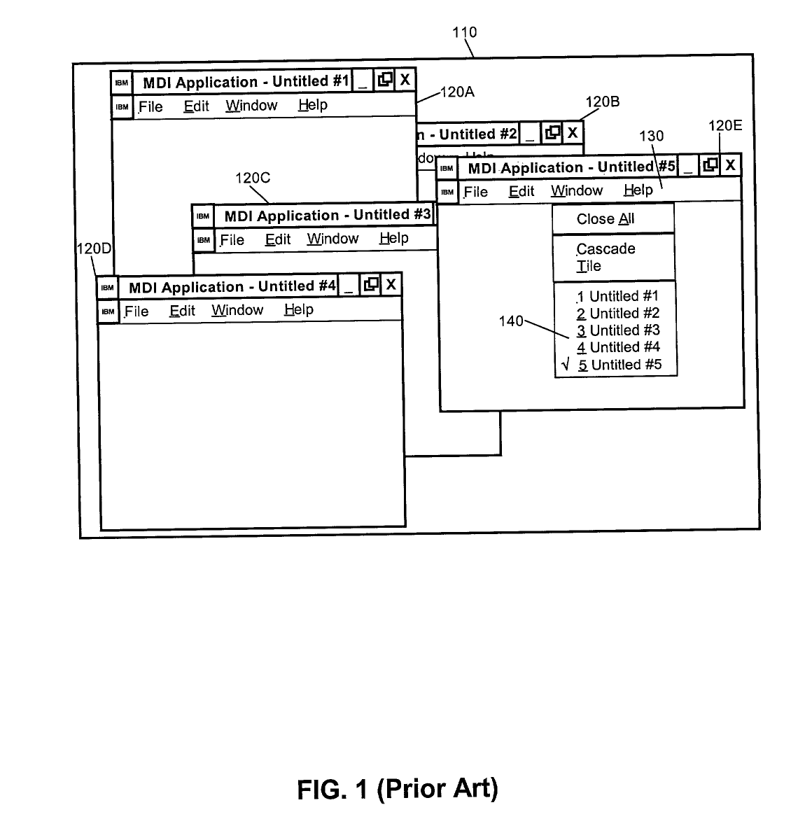

FIG. 2 is a screen shot of a multiple document interface architected application which has been configured in accordance with the inventive arrangements; and,

FIG. 3 is a pictorial illustration of a process for manipulating an open document window from the pull-down menu of another open document window in the multiple document interface architected application of FIG. 2.

### DETAILED DESCRIPTION OF THE PREFERRED EMBODIMENTS

The present invention is a method, system and apparatus for manipulating multiple open document windows in an application through the pull-down menu of any one of the multiple open document windows. In accordance with the present invention, the pull-down menu bar of each open document window in an application can be configured with a pull-down menu list of open document windows associated with the application. Each listed document window can have a corresponding window manipulation interactive user interface element, for example a button. In this way, a selected open document window in the pull-down menu list can be manipulated through another open document window without requiring the activation of the selected open document window.

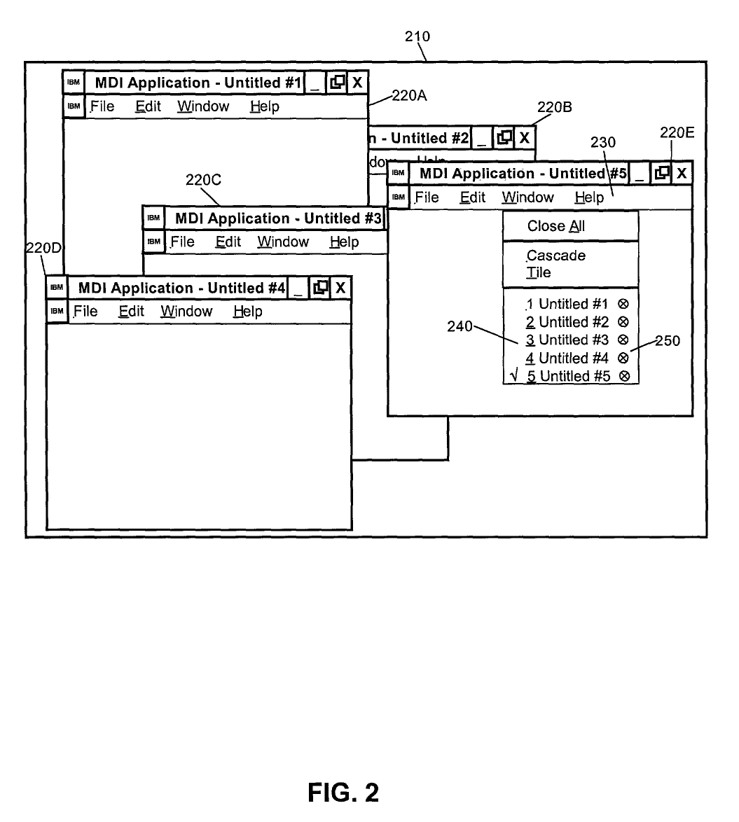

FIG. 2 is a screen shot of a multiple document interface (MDI) architected application which has been configured in accordance with the inventive arrangements. As will be apparent to one skilled in the art, however, the invention is not limited merely to MDI applications. Rather, as the present invention relates to the manipulation of multiple open document windows through the pull-down menu of a single open document window, other user interface architectures will be within the scope of the invention, including SDI applications.

As shown in FIG. 2, screen space 210 can host the graphical user interface of an application. The operation of the application can cause the creation and display of multiple document windows 220A, 220B, 220C, 220D, 220E. Notably, each open document window 220A, 220B, 220C, 220D, 220E further can include a menu bar 230, the creation of which is well-known in the art of windowing application development. In accordance with the inventive arrangements, a pull-down menu item of the menu-bar can include a menu listing 240 of open document windows associated with the application. As will be apparent from FIG. 2, the menu listing 240 further can indicate the currently activated open document window.

Advantageously, each open document window listed in the menu listing 240 can include a corresponding interactive graphical user interface element 250, for example a button. Each interactive graphical user interface element 250, in turn can trigger the execution of a pre-defined window manipulation operation, for example a window close operation, a document save operation, or a window print operation. In any case, the invention is not to be limited strictly to the window manipulation operations specified herein, and any such window manipulation operation can suffice.

Though FIG. 2 depicts the inclusion of all open document windows in the menu listing 240, in other aspects of the present invention, merely a selection of open document windows can be included, for instance only those open document windows displaying a particular file type. Likewise, windows other than document windows can be included in the menu listing 240, for instance dialog boxes or message boxes. In the case of non-document windows like dialog boxes or message boxes, the non-document windows can be dismissed through activation of a corresponding interactive user interface element 250 as if the cancel or OK button in the non-document window had been selected directly.

Notably, in a further aspect of the present invention, the menu listing 240 can include a selection of operating system services. Such operating system services can include conventional services such as network services, fixed storage access services, remote access services and the like. Thus, where a listing of the selection of operating system services is included in the menu listing 240, along with corresponding interactive user interface elements 250, those services can be started, stopped or disabled directly from the menu listing 240 without requiring the end user to navigate through to a control panel of services.

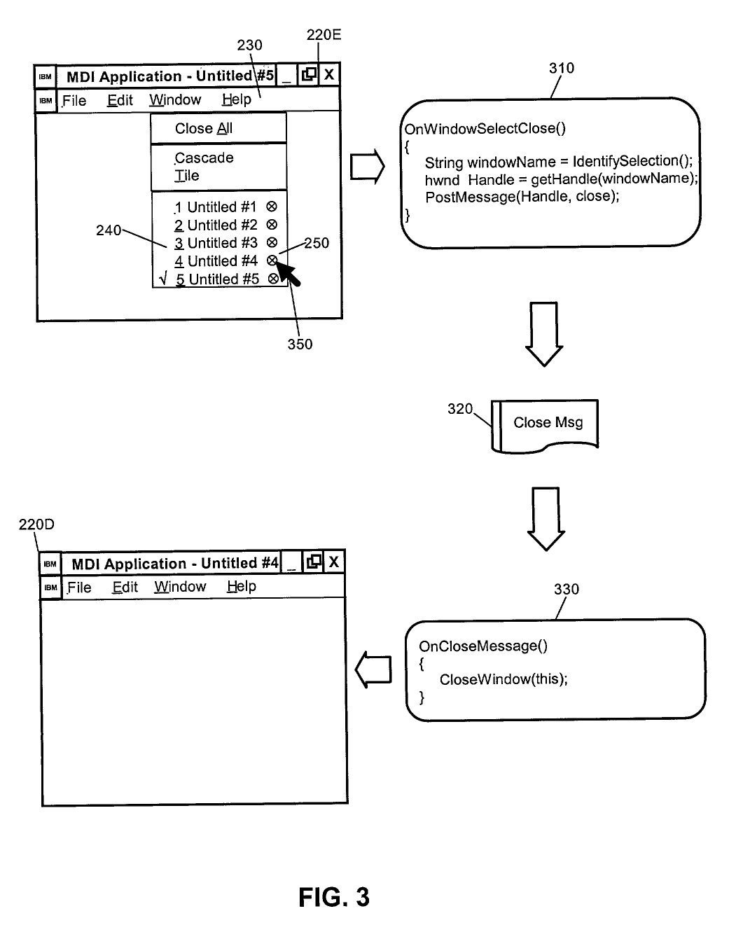

FIG. 3 is a pictorial illustration of an exemplary process for manipulating an open document window from the pull-down menu of another open document window in the MDI architected application of FIG. 2. As shown in FIG. 3, a user can activate an interactive user interface element 250 corresponding to a selected inactive open document window 220D from within an active open document window 220E. Upon activation of the interactive user interface element 250, a corresponding event can be generated and the event can be handled in a pre-configured message handling process 310 for the active open document window 220E. Importantly, the generation of window events and the handling thereof in a messaging handling process are concepts which are well-known in the art of windowing application development.

Once the message handling process 310 has received the generated event, the open document window 220D corresponding to the activated interactive user interface element 250 can be identified. Notably, the identification of the corresponding open document window 220D can be performed in many ways, including for example, querying the menu list 240 for the string associated with the activated interactive user interface. Alternatively, the generated event can include the name of the corresponding open document window 220D. Yet another alternative method for identifying the corresponding open document window 220D can include passing the window handle to the corresponding open document window 220D into the event.

Still, the invention is not limited in any regard to the various ways in which the corresponding open document window 220D can be identified. Rather, in accordance with the inventive arrangements, once the corresponding open document window 220D has been identified, a pre-configured event can be posted to the identified open document window 220D, for example a CloseWindow message 320. Once the message 320 has been received in the message handler 330 of the corresponding open document window 220D, the message can be processed in the same manner as if the event had been generated in consequence of direct user interaction with the identified open document window 220D.

Hence, no longer are users required to activate individual ones of the multiple open document windows for manipulation. Rather, in consequence of the present invention, centralized access can be provided to multiple open document windows of an application. Thus, the burdensome process formerly associated with the prior art can be overcome. Notably, the present invention can be realized in software in a centralized fashion in one computer system, or in a distributed fashion where different elements are spread across several interconnected computer systems. Any kind of computer system, or other apparatus adapted for carrying out the methods described herein, is suited to perform the functions described herein.

A typical centralized implementation could include a general purpose computer system with a computer program that, when being loaded and executed, controls the computer system such that it carries out the methods described herein. Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A method for manipulating multiple open document windows through a pull-down menu of an activated open document window comprising the steps of:
creating a pull-down menu in the activated open document window comprising a listing of open document windows and corresponding interactive user interface elements; and,
responsive to the activation of one of said interactive user interface elements, performing a pre-defined window manipulation operation upon an inactive open document window corresponding to said activated interactive user interface element.

2. The method of claim 1, wherein said performing step comprises the steps of:
generating a window manipulation event responsive to said activation of said interactive user interface element;
processing said window manipulation event in a message handling routine associated with the activated open document window, said processing comprising identifying said inactive open document window corresponding to said interactive user interface element, and posting a window manipulation event to said identified inactive open document window; and,
processing said posted window manipulation event in a message handling routine associated with said inactive open document window.

3. The method of claim 1, wherein said pre-defined window manipulation operation comprises a window manipulation operation selected from the group consisting of a window close operation, a print window operation, and a file save operation.

4. A system for manipulating multiple open document windows comprising:
a pull-down menu disposed in an active open document window;
a list of open document windows disposed in said pull-down menu;
a set of activatable interactive user elements disposed in said pull-down menu, each activatable interactive user element corresponding to one of said listed open document windows, each said activatable interactive user element having a screen position in said pull-down menu which is adjacent to said corresponding listed open document window; and,
an event handler configured to post pre-defined window manipulation events to inactive open document windows associated with activated ones of said activatable interactive user elements.

5. The system of claim 4, wherein each said activatable interactive user element comprises a button.

6. The system of claim 4, wherein said pre-defined window manipulation events comprise close window events.

7. A machine readable storage having stored thereon a computer program for manipulating multiple open document windows through a pull-down menu, said computer program comprising a routine set of instructions for causing the machine to perform the steps of:
creating a pull-down menu comprising a listing of open document windows and corresponding interactive user interface elements; and,
responsive to the activation of one of said interactive user interface elements, performing a pre-defined window manipulation operation upon an inactive open document window corresponding to said activated interactive user interface element.

8. The machine readable storage of claim 7, wherein said performing step comprises the steps of:
generating a window manipulation event responsive to said activation of said interactive user interface element;
processing said window manipulation event in a message handling routine associated with said activated open document window, said processing comprising identifying said inactive open document window corresponding to said interactive user interface element, and posting a window manipulation event to said identified inactive open document window; and,
processing said posted window manipulation event in a message handling routine associated with said inactive open document window.

9. The machine readable storage of claim 7, wherein said pre-defined window manipulation operation comprises a window manipulation operation selected from the group consisting of a window close operation, a print window operation, and a file save operation.

10. A method for manipulating multiple operating system services through a pull-down menu in an activated open document window comprising the steps of:
creating a pull-down menu in the activated open document window, said pull-down menu comprising a listing of selected operating system services and corresponding interactive user interface elements; and,
responsive to the activation of one of said interactive user interface elements, performing a pre-defined operating system services manipulation operation upon an operating system service corresponding to said activated interactive user interface element.

11. The method of claim 10, wherein said performing step comprises the steps of:
generating an operating system services manipulation event responsive to said activation of said interactive user interface element; and,
processing said operating system services manipulation event in a message handling routine associated with the activated open document window, said processing comprising identifying said operating system service corresponding to said interactive user interface element, and posting an operating system services manipulation event to said identified operating system service.
